(19) United States
(12) Patent Application Publication
(10) Pub. No.: US 2011/0285478 A1
(43) Pub. Date: Nov. 24, 2011

(54) PRECISION ALLOY

(76) Inventor: MASAHIRO NOMURA, Tokyo (JP)

(21) Appl. No.: 13/195,590

(22) Filed: Aug. 1, 2011

Related U.S. Application Data
(63) Continuation of application No. 12/439,940, filed on Mar. 4, 2009.

(30) Foreign Application Priority Data
Sep. 26, 2006 (JP) 2006-260261
Dec. 13, 2006 (JP) 2006-335462

(51) Int. Cl. H01P 3/00; B22D 17/00; B22D 19/00

(52) U.S. Cl. 333/239; 164/98

(57) ABSTRACT

A precision alloy for die-casting contains aluminum, silicon and zinc, wherein on the basis of the overall mass, the content of aluminum is 40% by mass or more and 45% by mass or less, and the content of silicon is 2% by mass or more and 8% by mass or less. Also other solving means will be described.

### REFERENCE TO RELATED APPLICATION

This is a continuation application of U.S. patent application Ser. No. 12/439,940 filed Mar. 4, 2009 and claims the benefit of its priority.

### TECHNICAL FIELD

The present invention relates to a precision alloy, in particular to a precision alloy for die-casting, a precision alloy die-cast component using the same, and a method of manufacturing a precision alloy for die-casting.

### BACKGROUND ART

Among components used for communication instruments, enclosure components for outdoor use, and high-frequency circuit instruments containing printed circuit hoards mounted with electronic circuit elements are generally configured as functional devices having metal cases or enclosed in metal covers, because of need of electromagnetic shielding. Also from the viewpoint of corrosion resistance, JIS-specified ADC3, a kind of aluminum alloy die-cast material, has been used.

Method of manufacturing the above-described mechanism components include cutting and die-casting. Aluminum is most general as the metal material. In particular, mass production inevitably needs manufacturing based on die-casting. There is, however, a wide variety in geometries (appearance, inner compartment walls) of cast cases, so that the largest disadvantage resides in that products will not be ejectable unless otherwise they are tapered (generally at an angle of 2 to 3° for each side). It has been known that ADC3, which is poor in castability, needed still larger draft.

Known methods of solving the problem are as

1) The cast products are subjected to machining, in order to shape them into necessary geometry.

2) A zinc-base alloy for die-casting is used as a material to be cast. The taper having previously been required may be no more necessary, and thereby the secondary processing may be reduced. The zinc-base alloy for die-casting may be exemplified by ZDC2 (Zn-4Al-0.04Mg) specified by JIS.

However, the method 1) may be difficult to avoid casting failure (blow-hole) after the secondary processing, and may fail in attaining a desired effect of cost reduction depending on types and quantity of the elements to be processed. In addition, the method needs preliminary evaluation of items including gradient shape, and therefore needs a long duration of time before launching the product.

The method 2) is largely limited in the mass design, since zinc (Zn) has a specific gravity larger than that of aluminum (Al) (zinc is 7.1 g/cm³, which is 2.6 times as large as Al of 2.7 g/cm³). Moreover, taking the corrosion resistance and creep characteristics into consideration, ZDC2 has not satisfied functions required for high-frequency components, in particular for circuit section of waveguide and coupling section of the same. In particular, ZDC2 has not been satisfactory for products for outdoor use where the alloy is used also as the enclosures, from the viewpoint of sacrificial corrosion resistance of zinc.

Patent Document 1 discloses a technology regarding a high-strength zinc alloy for die-casting having a tensile strength of 45 kgf/mm or larger, not causative of age softening, and castable at a temperature of 500° C. or lower. The document describes that, among Zn alloys, particularly those having high Al contents are not preferable since they may cause age softening, so that the Al content preferably resides in the range from 12 to 30% by mass. It is also described that the copper content preferably resides in the range from 6 to 20% by weight.

Patent Document 2 discloses a technology regarding a zinc alloy for die-casting, containing nickel (Ni) or manganese (Mn) for the purpose of improving creep resistance of zinc (Zn)-aluminum (Al)-base alloy. The Al content herein is reportedly 2 to 10% by weight.

Patent Document 3 discloses an alloy for hot-dip galvanizing, and in particular a Si-containing alloy to be supplied to a zinc plating bath.

Patent Document 4 discloses a method of manufacturing an Al—Zn—Si-base alloy material, in which extrusion is carried out while setting the alloy billet temperature to 250 to 350° C. The technology disclosed in Patent Document 4 relates to an alloy material used for low-temperature brazing filler material and so forth. In contrast, alloys for die-casting need be strictly limited in the ratio by mass of constitutive element, in order to satisfy heat radiation characteristics, weight reduction and castability such as draft.

[Patent Document 1] Japanese Laid-Open Patent Publication No. H6-49572

[Patent Document 2] Japanese Laid-Open Patent Publication No. H9-272932

[Patent Document 3] Japanese Laid-Open Patent Publication No. 2001-288519

[Patent Document 4] Japanese Laid-Open Patent Publication No. H5-255822

### DISCLOSURE OF THE INVENTION

However, the conventional technologies described in the documents in the above still have rooms for improvement as described below.

The zinc alloy for die-casting is a material having long been used by virtue of its intrinsically excellent castability, and has recently been developed mainly for the purpose of improving the creep characteristics, which are disadvantages contradictory to castability.

However, there has been known no zinc alloy which is developed from the viewpoint of allowing precise casting, despite of their known excellent castability as a solid metal. In other words, there has been known no zinc alloy capable of ensuring geometrical accuracy equivalent to that attainable by machining.

The present invention was conceived after considering the above-described situation. It is therefore an object of the present invention to provide a precision alloy capable of extremely reducing the draft of products as compared with those made of the conventional aluminum alloys for die-casting, and reduced in the specific gravity while keeping intrinsic advantages of zinc.

According to the present invention, there is provided a precision alloy for die-casting containing aluminum, silicon and zinc, wherein on the basis of the overall mass, the content of aluminum is 40% by mass or more and 45% by mass or less, and the content of silicon is 2% by mass or more and 8% by mass or less.

According to the present invention, there is provided also a precision alloy for die-casting containing 40% by mass or more and 45% by mass or less of aluminum, 2% by mass or more and 8% by mass or less of silicon, and the balance of zinc and inevitable impurities.

According to the present invention, there is provided still also a precision alloy for die-casting containing 40% by mass or more and 45% by mass or less of aluminum, 2% by mass or more and 8% by mass or less of silicon, 0.1% by mass or more and 0.2% by mass or less of copper, 0.01% by mass or more and 0.1% by mass or less of magnesium, and the balance of zinc and inevitable impurities.

According to the present invention, there is provided still also a precision alloy die-cast component composed of the precision alloy for die-casting of the present invention.

According to the present invention, there is provided still also a method of manufacturing a precision alloy for die-casting, the method includes: obtaining a molten metal containing aluminum, zinc, silicon, copper, and magnesium; and obtaining a precision alloy for die-casting containing, on the basis of the overall mass, 40% by mass or more and 45% by mass or less of aluminum, 30% by mass or more and 57.89% by mass or less of zinc, 2% by mass or more and 8% by mass or less of silicon, 0.1% by mass or more and 0.2% by mass or less of copper, 0.01% by mass or more and 0.1% by mass or less of magnesium, and inevitable impurities.

According to the present invention, a precision alloy for die-casting, reduced in the specific gravity while keeping intrinsic advantages of zinc, and capable of extremely reducing the draft of products as compared with those made of the conventional aluminum alloys for die-casting, may be provided.

### BRIEF DESCRIPTION OF THE DRAWINGS

The above and other objects, features and advantages of the present invention will be more apparent from the following description of certain preferred embodiments taken in conjunction with the accompanying drawings.

FIG. 1 is a sectional view illustrating a precision alloy die-cast component of Example A6. A is a front elevation, B is a right side elevation, C is a sectional view of an aperture portion on the upper and lower sides of the front elevation, D is a sectional view taken at the center of the front elevation, and E is a rear elevation, wherein portions G and F in the sections are portions indicating points of change in the direction of propagation of electric wave propagating through the waveguide illustrated as the non-hatched portions in the rear elevation.

### BEST MODES FOR CARRYING OUT THE INVENTION

A precision alloy for die-casting of this embodiment contains aluminum, silicon and zinc, wherein on the basis of the overall mass, the content of aluminum is 40% by mass or more and 45% by mass or less, and the content of silicon is 2% by mass or more and 8% by mass or less.

The precision alloy for die-casting in this embodiment may contain 0.1% by mass or more and 0.2% by mass or less of copper, and 0.01% by mass or more and 0.1% by mass or less of magnesium.

In this embodiment, the lower limit of the zinc content is preferably 30% by mass, more preferably 35% by mass, and still more preferably 48% by mass. The upper limit of the zinc content is preferably 58% by mass, more preferably 57.89% by mass, still more preferably 57% by mass, and further more preferably 50% by mass.

Alternatively, the zinc content may be the balance of the alloy composed of aluminum, silicon, zinc, and inevitable impurities. Still alternatively, the zinc content may be the balance of the alloy composed of aluminum, silicon, zinc, copper, magnesium, and inevitable impurities.

By containing the above-described ranges of zinc, the alloy may be improved in the precision castablity. By virtue of the effect of precision castability, the secondary processing may no more be necessary, and the cost may consequently be reduced.

### EXAMPLES

The present invention will be explained referring to Examples.

Among Examples below, Examples A1 to A4 and B1 to B4 are those explaining the precision alloy for die-casting, and Example A5 explains the method of manufacturing a precision alloy for die-casting according to the present invention. Examples A6 to A9 are those explaining the die-cast component using the precision alloy for die-casting according to the present invention.

Note that any numerical ranges expressed herein by using “ . . . to . . . ” mean the ranges including the numerals placed before and after “to”, as the lower limit and the upper limit, respectively.

### Example A1

Alloy 1 containing aluminum, zinc and silicon was prepared.

The present invention is mainly aimed at carrying out precision casting, in particular reducing the draft to a lager degree, and at the same time, reducing the specific gravity of the alloy, while keeping an intrinsic advantage of zinc which functions as a solid metal lubricant. More specifically, the precision alloy for die-casting of the present invention is configured to contain 40 to 45% by mass of aluminum and 30 to 57% by mass of zinc as major metals, and contain 2 to 8% by mass of silicon, arbitrary composition-adjusting metal(s), and inevitable impurities.

Silicon (Si) shows an effect of improving castability (casting flow), and is useful for suppressing separation between Al and zinc, so as to make them uniformly disperse with each other. Although the Al content in the present invention is set larger than in the conventional zinc alloys, degradation in the castability due to increase in the Al content may be suppressed by addition of Si. As has been described in the above, Si may be said as an element absolutely absent in general zinc alloys specified, or not specified by JIS. In contrast, the present invention is based on a finding of Si addition, in view of attaining geometrical accuracy of zinc alloys equivalent to that attainable by machining. In the present invention, Si supposedly functions as a lattice between Al and zinc elements, and at the same time suppresses shrinkage during solidification, and can thereby carry out precision casting, or in other words, can considerably reduce the draft.

The Si content may preferably be adjusted to the range from 2 to 8% by mass, and more preferably 4 to 7% by mass on the basis, of the overall mass of alloy, while taking also the weight of Al into consideration.

The Si content may preferably be adjusted to approximately 6 to 15% by mass, relative to the ratio by mass of Al. Too small Si ratio by weight relative to the Al ratio by weight may tend to degrade the fluidity of alloy, on the other hand, too large Si ratio by weight relative to the Al ratio by weight may tend to degrade toughness, and may thereby embrittle the alloy, while raising no problem in the fluidity.

Aluminum (Al) contributes to elevate the strength and hardness of the alloy, and weight reduction of the alloy. In the precision alloy of the present invention, the Al content is preferably adjusted to 40 to 45% by mass, and more preferably to 42 to 45% by mass, based on the overall weight of alloy. Too small Al content may fail in achieving sufficient levels of the above-described characteristics, and may also degrade the fluidity. On the other hand, too large Al content may make it difficult to precisely cast the alloy (at a draft of 1/10 or smaller for each side). Conventionally, it has been considered that too large Al content in the zinc alloys is not preferable because of fear of age softening, instead a content of 12 to 30% by mass or around is preferable (Patent Document 1). In contrast in the present invention, degradation in the castability due to increase in the Al content may be avoidable by adding Si. For this reason, the Al content is adjusted larger than that in the conventional zinc alloys.

The zinc content is preferably adjusted to 30 to 57% by mass, and more preferably to 48 to 50% by mass, on the basis of the overall weight of alloy.

The precision alloy of the present invention may further contain inevitable impurities. The inevitable impurities herein mean substances unintentionally contained in the material in the process of manufacturing, and may be exemplified by iron, lead, cadmium, tin and so forth.

### Example A2

Alloy 2 containing aluminum, zinc, silicon, copper and magnesium was prepared. Alloy components of this Example are shown in Table 1.

The precision alloy of the present invention may further contain other composition-adjusting element(s) if necessary. As the composition-adjusting element(s), at least either of copper and magnesium, for example, may be contained.

Copper (Cu) functions to improve the machinability, and may preferably be adjusted to 0 to 0.5% by mass relative to the weight of zinc, in the precision alloy of the present invention. In the precision alloy of the present invention, the copper content may preferably be 0.1 to 0.2% by mass, and more preferably be 0.1 to 0.17% by mass relative to the overall weight of alloy. Too small copper content may fail in achieving sufficient levels of the above-described characteristics, on the other hand, too large content may degrade the fluidity.

Magnesium (Mg) functions to prevent intercrystalline corrosion which is believed to occur more frequently in Al-containing zinc alloys. In the precision alloy of the present invention, the magnesium content is preferably 0.01 to 0.1% by mass, and more preferably 0.01 to 0.07% by mass based on the overall weight of alloy. Too small Mg content may fail in achieving sufficient levels of the above-described characteristics, on the other hand, too large content may accelerate oxidation of the molten metal, and may consequently lower the impact strength.

### Example A3

Alloy 3 containing aluminum, zinc, silicon, copper and magnesium was prepared, according to the ratio of content shown in Table 1.

### Example A4

Alloy 4 containing 3.0% by mass of silicon, and containing aluminum, zinc, silicon, copper and magnesium was prepared.

### Example B1

This Example will explain an exemplary precision alloy for die-casting containing aluminum, zinc and silicon.

The present invention is mainly aimed at carrying out precision casting, in particular reducing the draft to a lager degree, and at the same time, reducing the specific gravity of the alloy, while keeping an intrinsic advantage of zinc which functions as a solid metal lubricant. The precision alloy for die-casting of the present invention contains aluminum, silicon and zinc, and contains 40 to 45% by mass of aluminum and 2 to 8% by mass of silicon, based on the total mass of alloy.

Si is preferably added in the range from 2 to 8% by mass, and more preferably from 4 to 7% by mass based on the overall mass of alloy, also taking the weight of Al into consideration.

As described in the above, the Si content is preferably adjusted to the range from approximately 6 to 15% by mass, relative to the mass of Al.

In the precision alloy of the present invention, as described in the above, the Al content is preferably 40 to 45% by mass, and more preferably 42 to 45% by mass, based on the overall mass of alloy.

The zinc content is preferably 35 to 58% by mass, and more preferably 48 to 50% by mass, based on the overall mass of alloy. Alternatively, the zinc content may be the balance of the alloy which contains the above-described ranges of aluminum and silicon, and inevitable impurities.

By containing the above-described ranges of zinc, the alloy may be improved in the precision castablity. By virtue of the effect of precision castability, the secondary processing may no more be necessary, and the cost may consequently be reduced.

The precision alloy of the present invention may further contain the inevitable impurities described in the above.

Characteristics required for alloys for die-casting include (1) mechanical strength and machinability, (2) heat radiation characteristics, (3) creep resistance characteristics, (4) corrosion resistance, (5) weight reduction, and (6) castability (small draft), all of which are necessarily satisfied. In particular, the above-described (2), (5) and (6) are critical in view of providing a material substitutive to Al alloys for die-casting, wherein it may be critical to strictly limit percentages by mass of alloy components, for the purpose of satisfying these requirements at the same time. The precision alloy of the present invention are well balanced among the characteristics required for alloys for die-casting.

### Example B2

The Example will explain an exemplary precision alloy containing aluminum, silicon, copper, magnesium and zinc.

The zinc content in this example preferably falls in the range from 35 to 57.89% by mass, and more preferably from 48 to 50% by mass, based on the overall mass of alloy. Alternatively, the zinc content may be the balance of the alloy which contains aluminum, silicon, copper, magnesium, and inevitable impurities.

By containing the above-described ranges of zinc, the alloy may be improved in the precision castablity, the secondary processing may no more be necessary, and the cost may consequently be reduced.

The precision alloy of this Example further contains copper and magnesium, in addition to the alloy components in Example B1.

As described in the above, the content of copper (Cu), when contained in the precision alloy of the present invention, may preferably be adjusted to 0 to 0.5% by mass relative to the weight of zinc. In the precision alloy of the present invention, the copper content is preferably adjusted to 0.1 to 0.2% by mass, and more preferably to 0.1 to 0.17% by mass, based on the overall weight of alloy.

As described in the above, the content of magnesium (Mg), intended for inclusion into the precision alloy of the present invention, may preferably be adjusted 0.01 to 0.1% by mass, and more preferably to 0.01 to 0.07% by mass, based on the overall mass of alloy.

By further containing above-described ranges of Cu and Mg, the precision alloy of the present invention may further be improved in the balance among characteristics required for precision alloys for die-casting. In a particular case where Cu and Mg are added, the above-described (1) mechanical strength and machinability, (3) creep resistance characteristics, and (4) corrosion resistance may further be improved. In particular, as compared with the conventional Al alloys such as ADC3, the precision alloy for die-casting may be obtained in a form, while achieving equivalent or more excellent creep resistance characteristics, improved in other mechanical strength, and being well balanced among the mechanical characteristics.

TABLE 1

| | | Al | Zn | Cu | Mg | Si | Fe | Pb | Cd | Sn |
|---|---|---|---|---|---|---|---|---|---|---|
| | | unit: | unit: | unit: | unit: | unit: | unit: | unit: | unit: | unit: |
| | Number | % | % | % | % | % | % | ppm | ppm | ppm |
| Example A2 | Alloy 2 | 44.30 | 49.03 | 0.122 | 0.028 | 6.41 | 0.110 | 7.4 | — | 1.8 |
| Example A3 | Alloy 3 | 44.70 | 43.71 | 0.120 | 0.027 | 6.34 | 0.103 | 6.0 | — | 1.2 |

### Example B3

Alloy 5 containing aluminum, copper, magnesium and silicon according to the compositional ratio shown in Table 2, and containing the balance of zinc and inevitable impurities, was prepared.

TABLE 2

| | | Al | Cu | Mg | Si | Zn |
|---|---|---|---|---|---|---|
| | | unit: % | unit: % | unit: % | unit: % | unit: % |
| | | by mass | by mass | by mass | by mass | by mass |
| Example B3 | Alloy 5 | 45.00 | 0.12 | 0.02 | 6.00 | balance |

The mechanical strength and castability of Alloy 5 were measured. Results are shown in Table 3.

The tensile strength herein was measured conforming to JIS Z2242, and the high-temperature creeping was measured conforming to JIS Z2271. The hardness was measured conforming to Vickers hardness test specified by JIS B7725.

The low-temperature brittle fracture was measured according to the procedures below.

One heat-insulating box (400 mm×200 mm×150 mm) and two blocks of dry ice (100 mm×100 mm×100 mm) were obtained. A test piece of Alloy 3 (6 mm×6 mm×80 mm) was sandwiched by the dry ice blocks, and allowed to stand in the heat-insulating box together with other dry ice blocks for approximately one hour. In this process, also a setting jig (tweezers) was cooled by allowing it to stand in the same heat-insulating box. Next, the test piece and the dry ice blocks were separated in the heat-insulating box, and the test piece was taken out using the tweezers. The test piece was attached to a predetermined position of a Charpy impact tester specified by JIS B7779. The interval between the taking-out of the test piece from the heat-insulating box and the attachment to the tester was approximately 3 seconds. After being attached, the test piece was applied with impact until it fractured. The length of time between the attachment and the fracture of the test piece was approximately 5 seconds.

### Comparative Example 1

A commercially-available ADC3 was obtained. The mechanical strength and castability were measured according to the procedures similar to those in Example B3. Results are shown in Table 3.

TABLE 3

| | | | Comparative |
|---|---|---|---|
| | | Example B3 | Example 1 |
| Alloy | | Alloy 5 | ADC3 |
| Mechanical | Tensile strength [N/mm²] | 480 | 280 |
| strength | Low-temperature brittle | 6.8 | 6 |
| | fracture [J] | | |
| | High-temperature creeping | ≦0.01 | ≦0.01 |
| | (ε-T curve) [%] | | |
| | Specific gravity [g/cm³] | 3.8 | 2.7 |
| | Hardness [HV] | 150< | 100 |
| Castability | Draft [°] | ≦0.1 | 2 |

As shown in Table 3, Alloy 5 showed desirable results in the tensile strength, low-temperature brittle fracture and hardness, as compared with the existing alloy (ADC3). The high-temperature creeping of alloy 5 was found to be at a level equivalent to that of ADC3, proving that Alloy 5 showed, as a whole, desirable characteristics well balanced in the mechanical strength. Alloy 5 was also found to be considerably lowered in the specific gravity, despite being a zinc-base alloy, as compared with the conventional zinc alloy materials for die-casting, and found to be successful in weight reduction. Alloy 5 was still also found to be reduced in the draft to an extreme degree as compared with ADC3, proving its improved castability.

### Example B4

An alloy containing aluminum and zinc as major components, and additionally containing silicon, copper and magnesium was prepared (silicon content=3.0% by mass). It is supposed that also this alloy may be successful in achieving mechanical strength and castability equivalent to those of Alloy 3.

A specific feature of the alloys obtained in these Examples is that, despite beinge zinc-base alloys, they have a specific gravity of 3.8 g/cm³, which is 54%, or approximately half, of that of the conventional zinc alloy materials for die-casting. When compared among general metals for industrial use, they are the third-lightest metals after magnesium (1.74) and aluminum (2.70). By virtue of this compositional ratio, the draft which has conventionally been necessary in casting (generally tapered at an angle of 2 to 3° for each side) may be reduced to as small as ⅕ to 1/10. Even zero draft may be permissive, if the length of contact between the die and metal is 20 mm or shorter. Therefore, the secondary processing may be omissible, limitations such as thinning of the end portions of inner compartment walls may be avoidable, and thereby limitations on the design may be improved to a large degree.

### Example A5

In this Example, a method of manufacturing the precision alloy for die-casting of the present invention will be explained.

The precision alloy for die-casting of the present invention may be prepared by obtaining a molten metal containing aluminum, zinc and silicon, and arbitrarily containing copper and magnesium. For example, it may be prepared in a form of aluminum-silicon binary alloy, or so-called master alloy, while being melted together with other metals in a graphite crucible, or alternatively be prepared by obtaining a molten metal containing an electrolytic zinc as a base and desired amounts of Al, Cu and Mg melted therewith into a form of base metal (or, master alloy), and by directly adding Si to the molten metal.

According to the method of this Example, the alloy was successfully prepared by allowing an zinc-containing, aluminum-silicon binary alloy to melt in a form of so-called master alloy, in a graphite crucible.

### Example A6

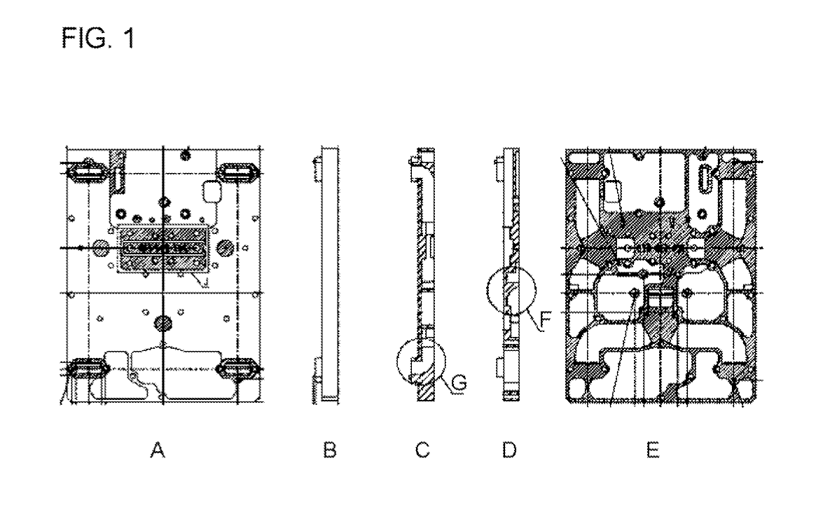

A die-cast mechanism component having a high-frequency circuit section, manufactured by using Alloy 11 in Example Al is illustrated in FIG. 1. This is an example of high-frequency circuit component, and has generally been manufactured by aluminum die-casting. Portions G and F in the drawings are portions indicating points of change in the direction of propagation of electric wave propagating through the waveguide illustrated as the non-hatched portions in the rear elevation. Conventionally, the component was formed into an approximated shape by casting, and was then ensured with a necessary level of dimensional accuracy, typically by removing the draft on the side faces thereof by cutting or electric discharge machining. In other words, the conventional alloy for die-casting could not get rid of procedures for secondary processing, after being obtained in a form of casting.

Now, the non-hatched portions in FIG. 1(E) are most important waveguides, having on the left side thereof apertures allowing therethrough entrance and exit of the electric wave (at two locations on the left and right sides, in the upper and lower portions). The conventional die-casting using aluminum alloy materials needed drafts, so that almost all apertures, rectangular openings, trenches and waveguide sections needed secondary processing. In contrast, in this Example, the processing was necessary only for threading (lower hole was formed by casting), and for finishing of the surface brought into contact with a printed circuit board. As a consequence, the cost was decreased by 40% as compared with the conventional component.

### Examples A7 to A9

Die-cast mechanical components having high-frequency circuits were manufactured using Alloys 2 to 4 prepared in Examples A2 to A4, by a method similar to that described in Example A6. Similarly to Example A6, the die-cast components almost needing no secondary processing were successfully obtained.

The present invention was explained referring to Examples. A first effect of the present invention is that the draft of the products may extremely be reduced, as compared with conventional aluminum alloy materials for die-casting. As a consequence, elements for the secondary processing (machining) may extremely be reduced. Since almost all portions processed by drilling, square drilling, trench formation and pocketing may be castable with nearly straight profiles (even without inclination depending on sites), so that the components may be manufactured most simply at low cost.

A second effect of the present invention is that the components may preliminarily be evaluated while keeping accuracy (size and geometry) of the components unchanged, without needing preliminarily electrical evaluation of components with gradient to be machined, and thereby the products may be launched earlier. In particular, for the mechanism components having ultra-high-frequency waveguides formed therein, the lead time for development may be shortened to a large degree.

A third effect of the present invention is that any existing dies manufactured for producing drafted products may be modified into dies for precision casting, by additional machining. As a consequence, costs of the existing products may further be reduced.

A fourth effect of the present invention is that the precision alloy is superior to the conventional aluminum alloy materials for die-casting (ADC3, for example) in terms of castability. The precision alloy of the present invention is increased in the specific gravity 1.4-fold, but may reduce the average thickness of the products to 70%, without affecting the mass of products. As a consequence, the mass of product may be adjustable equivalently to those made of aluminum alloy.

As is clear from the above, use of the precision alloy of the present invention raises a large effect in that the products equivalent to conventional machined components may be obtainable by die-casting.

Use of the precision alloy for die-casting of the present invention enables casting with preciseness comparable to preciseness of machining. Realization of geometry comparable to that of machined components simply by the cast product per se provides a large degree of cost reduction and shortened period for the development and evaluation.

Descriptions have been made in the above, referring to Examples merely as exemplary cases of the present invention, while allowing adoption of various configurations other than those described in the above.

1. A cast case formed by die-casting with a precision alloy having a high-frequency circuit, wherein
a waveguide used as said high-frequency circuit has an aperture that a draft is approximately 0 and
said precision contains aluminum, silicon and zinc.

2. The cast case as claimed in claim 1, wherein the content of said aluminum is 40% by mass or more and 45% by mass or less, and the content of said silicon is 2% by mass or more and 8% by mass or less.

3. The cast case as claimed in claim 1, wherein the content of said zinc is 35% by mass or more and 58% by mass or less.

4. The cast case as claimed in claim 1, wherein said precision alloy comprises 40% by mass or more and 45% by mass or less of aluminum, 2% by mass or more and 8% by mass or less of silicon, and the balance of zinc and inevitable impurities.

5. The cast case as claimed in claim 2, wherein said precision alloy further contains 0.1% by mass or more and 0.2% by mass or less of copper.

6. The cast case as claimed in claim 2, wherein said precision alloy further contains 0.01% by mass or more and 0.1% by mass or less of magnesium.

7. The cast case as claimed in claim 1, wherein said aperture of said waveguide is formed by die-casting and said aperture is not subjected mechanical processing.

8. A method of manufacturing a cast case by die-casting with a precision alloy having a high-frequency circuit, the method comprising:
adjusting a precision alloy to contain aluminum, silicon and zinc as material for die-casting,
casting a cast case in said precision alloy with forming a waveguide used as said high-frequency circuit that a draft of said waveguide's aperture is appropriately 0, by die-casting.

9. The method of manufacturing a cast case as claimed in claim 8, wherein said waveguide's aperture formed by die-casting is not subjected mechanical processing thereafter.
